(19) United States
(12) Patent Application Publication
(10) Pub. No.: US 2012/0250288 A1
(43) Pub. Date: Oct. 4, 2012

(54) LIGHT SOURCE HEAT-DISSIPATION STRUCTURE OF BACKLIGHT MODULE

(75) Inventor: Chengwen Que, Shenzhen (CN)

(73) Assignee: Shenzhen China Star Optoelectronics Technology Co. Ltd, Shenzhen Guangdong (CN)

(21) Appl. No.: 13/000,989

(22) PCT Filed: Nov. 26, 2010
(86) PCT No.: PCT/CN2010/079151

§ 371 Date: Dec. 22, 2010

(30) Foreign Application Priority Data
Oct. 8, 2010 (CN) 2010007608.5

(51) Int. Cl. F21V 29/00

(52) U.S. Cl. 362/97.1

(57) ABSTRACT

The present invention provides a light source heat-dissipation structure of a backlight module having: a light-source structure, the heat-dissipation base and a carrier. The light-source structure has leads, respectively. The heat-dissipation base has a supporting surface, an attachment surface and first through holes. The carrier has second through holes, and the carrier is attached to the attachment surface of the heat-dissipation base. The light-source structure is set on the supporting surface of the heat-dissipation base, and the leads of the light-source structure pass through the first through holes and the second through holes and then electrically connect with the carrier. Hence, the heat-dissipation base may directly support and thermally contact the light-source structure for relatively enhancing the heat-dissipation efficiency of the light-source structure.

### FIELD OF THE INVENTION

The present invention relates to a light source heat-dissipation structure of a backlight module, and more particularly to a light source heat-dissipation structure of a backlight module using a heat-dissipation base with high heat-dissipation efficiency to fix a light-source structure and to help a light-emitting diode for effectively conducting heat and dissipating heat.

### BACKGROUND OF THE INVENTION

A liquid crystal display (LCD) is a kind of flat panel display (FPD), which shows images by the property of liquid crystal material. Comparing with other display devices, the liquid crystal display has the advantages in lightweight, compactness, low driving voltage and low power consumption, and thus has become the mainstream produce in the whole consumer market. However, the liquid crystal material of the liquid crystal display cannot emit light by itself, and must depend upon an external light source. Thus, the liquid crystal display further has a backlight module to provide the needed light beams.

Generally, the backlight module can be divided into two types: a side-light type backlight module and a direct type backlight module. Traditionally, the backlight module uses cold cathode fluorescent lamps (CCFLs), hot cathode fluorescent lamps (HCFLs) or semiconductor light emitting elements as the light source, wherein the semiconductor light emitting elements mainly use light emitting diodes (LEDs) to emit light. The light-emitting diode is better than the cold cathode fluorescent lamp in energy saving, longer lifetime, lightweight and compact volume, so that there is a trend to gradually replace the cold cathode fluorescent lamp and thus the light emitting diode will be the mainly light source of the backlight module for the liquid crystal display in the future.

Nowadays, the light emitting diode is usually assembled in a semiconductor chip type to be used as a light-emitting diode package structure which is then fixed to a strip-like circuit board to be used as a light bar, and finally a back surface of the light bar is connected to an aluminum heat-dissipation base of the backlight module. But, the disadvantage of the light source heat-dissipation structure is that a temperature of a light-emitting diode chip of the light-emitting diode package structure during working is very high, and the light-emitting diode package structure just can indirectly conduct heat energy to the aluminum heat-dissipation base through the circuit board though. Because of materials of the printed circuit board have high thermal resistance, the aluminum heat-dissipation base of the backlight module cannot timely dissipate the heat energy which comes from the light-emitting diode package structure. Thus, the temperature of the surroundings of the light-emitting diode package structure will obviously raise and cause uneven temperature distribution in each of display blocks of the liquid crystal display and a reddish phenomenon due to the high temperature, resulting in affecting the imaging quality of the liquid crystal display.

For example, referring to FIG. 1A, a schematic view of a light source heat-dissipation structure of a traditional side-light type backlight module, wherein the heat-dissipation structure 10 of the light source of the traditional side-light type backlight module mainly comprises at least one light-source structure 11, a heat-dissipation base 12 and a carrier 13.

Simultaneously referring to FIG. 1 B, a cross-sectional view of the light source heat-dissipation structure of the traditional side-light type backlight module, taken along the line A-A in FIG. 1A. The at least one light-source structure 11 has at least one light-emitting diode 111 and at least one lead 112, respectively. The at least one light-source structure 11 is mounted on a first surface 131 of the carrier 13, and the at least one lead 112 of the at least one light-source structure 11 is electrically connected to a circuit (non-shown) on the first surface 131 of the carrier 13. A second surface 132 of the carrier 13 is attached to an attachment surface 121 of the heat-dissipation base 12, so that the at least one light-source structure 11 can dissipate heat through the heat-dissipation base 12 on the carrier 13. The thermal conductivity of the carrier 13 of the light source heat-dissipation structure of the traditional side-light type backlight module is smaller, and the heat energy which comes from the at least one light-source structure 11 cannot be efficiently conducted to the heat-dissipation base 12.

Moreover, the light-emitting diode is very easy influenced in a luminous efficiency and stability because of the increasing temperature thereof during working, and a serious consequence may lower the lifetime of the light-emitting diode due to the long-term high temperature situation. Besides, if the light-emitting diode package structure is just simply attached on the aluminum heat-dissipation base by an adhesives or fixed on the aluminum heat-dissipation base by screws, the efficiency of the conducting heat will be influenced to a certain extent due to indirectly thermal contact between the circuit board of the light bar and the aluminum heat-dissipation base, insulating adhesives existing therebetween, or un-tightly surface attachment therebetween, and the thickness of whole structure will also be increased and thus not helpful to the design trend of compactness. In addition, under the long-term high temperature situation, the adhesives may deteriorate and lose viscosity, so that the light bar will depart from the aluminum heat-dissipation base. If the heat of the light-emitting diode package structure can not be timely dissipated by the fixed plate, there will be a potential risk in overheat damage of the light-emitting diode package structure.

### SUMMARY OF THE INVENTION

A primary object of the present invention is to provide a light source heat-dissipation structure of a backlight module, and that is to provide a light source heat-dissipation structure to the light-emitting diode of the backlight module for solving traditional problems in thermal dissipating technology.

The present invention is to provide a light source heat-dissipation structure of a backlight module, which comprise at least one light-source structure, a heat-dissipation base and a carrier, wherein the heat-dissipation base directly supports and thermally contacts the light-source structure. Thus, it is helpful for the light-source structure to directly conduct heat and dissipate heat in accordance by good properties of thermal conductivity and heat-dissipation of the heat-dissipation base, so that the heat-dissipation efficiency and the lifetime of the light-source structure can be relatively enhanced

The present invention is to provide a light source heat-dissipation structure of a backlight module, wherein the light-source structure, the heat-dissipation base and the carrier are combined with each other in turn, so that the carrier will not be directly affected by the heat energy which comes from the light-source structure. Hence, the lifetime of the carrier can be relatively enhanced.

The present invention is to provide a light source heat-dissipation structure of a backlight module, wherein the light-source structure, the heat-dissipation base, and the carrier are combined with each other in turn, and fillers which are filled in through holes of the heat-dissipation base and the carrier not only electrically isolate leads of the light-source structure from the heat-dissipation base, but also the fillers may help the heat-dissipation base is firmly combined with the carrier. Thus, it is unnecessary to use thermal conductive adhesives between the heat-dissipation base and the carrier, so as to lower the production cost and the whole thickness for carrying out the purpose of compacting products.

To achieve the above object, the present invention provides a light source heat-dissipation structure of a backlight module, wherein the light source heat-dissipation structure of the backlight module comprises: at least one light-source structure, each of which comprises at least one lead; a heat-dissipation base having a supporting surface, an attachment surface and at least one first through hole; and a carrier having a first surface and at least one second through hole, wherein the first surface is attached to the attachment surface of the heat-dissipation base, wherein the at least one light-source structure is mounted on the supporting surface of the heat-dissipation base, and the at least one lead passes through the at least one first through hole of the heat-dissipation base and the at least one second through hole of the carrier and electrically connects to the carrier.

In one embodiment of the present invention, each of the light-source structure further comprises at least one light-emitting diode.

Furthermore, the present invention provides another light source heat-dissipation structure of a backlight module, wherein the light source heat-dissipation structure of the backlight module comprises: at least one light-source structure, each of which comprises at least one light-emitting diode and at least one lead; a heat-dissipation base having a supporting surface, an attachment surface and at least one first through hole, wherein the at least one first through hole passes through the supporting surface and the attachment surface; and a carrier having a first surface, a second surface and at least one second through hole, wherein the at least one second through hole passes through the first surface and the second surface, and the first surface is attached to the attachment surface of the heat-dissipation base, wherein the light-emitting diode of the light-source structure is mounted on the supporting surface of the heat-dissipation base, and the at least one lead passes through the at least one first through hole of the heat-dissipation base and the at least one second through hole of the carrier and electrically connects to the carrier.

In one embodiment of the present invention, the light source heat-dissipation structure is a side-light type light-emitting diode light bar or a direct type light-emitting diode light bar.

In one embodiment of the present invention, the at least one first through hole of the heat-dissipation base and the at least one second through hole of the carrier further comprises a filler, so that the at least one lead is fixed in the at least one first through hole and the at least one second through hole and the heat-dissipation base is combined with the carrier.

In one embodiment of the present invention, the filler is an insulating adhesive or other insulant to electrically isolate the at least one lead from the heat-dissipation base.

In one embodiment of the present invention, the carrier is a printed circuit board.

In one embodiment of the present invention, the heat-dissipation base is a metal heat-dissipation base or an alloy heat-dissipation base.

Comparing to the traditional technology, the light source heat-dissipation structure of the backlight module of the present invention uses the heat-dissipation base with better heat-dissipation efficiency to directly support and thermally contact the light-source structure. Thus, not only it can lower the production cost and whole thickness of the backlight module, but helpful for the light-source structure to directly conduct heat and dissipate heat in accordance with good properties of thermal conductivity and heat-dissipation of the heat-dissipation base, so that the heat-dissipation efficiency and the lifetime of the light-source structure can be relatively enhanced.

### DESCRIPTION OF THE DRAWINGS

FIG. 1A is a schematic view of a light source heat-dissipation structure of a traditional side-light type backlight module;

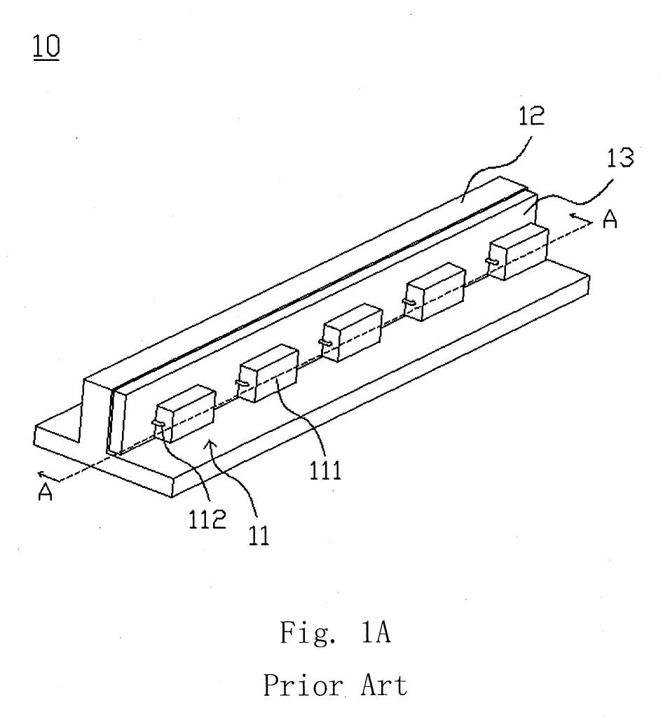

FIG. 1B is a cross-sectional view of the light source heat-dissipation structure of the traditional side-light type backlight module, taken along the line A-A in FIG. 1A;

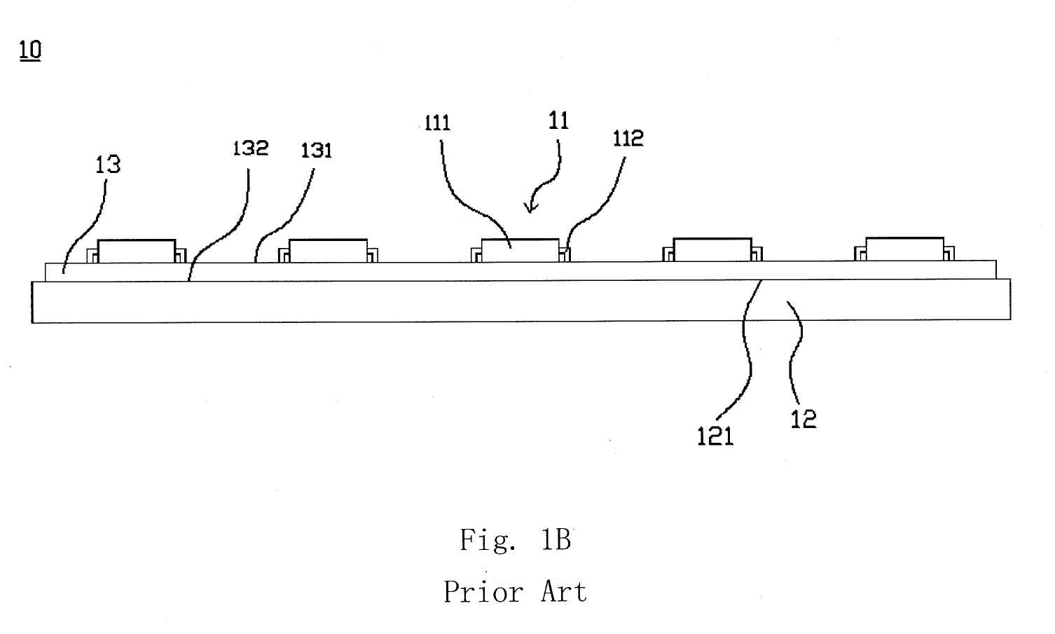

FIG. 2A is a schematic view of a light source heat-dissipation structure of a side-light type backlight module according to a first preferred embodiment of the present invention;

FIG. 2B is a cross-sectional view of the light source heat-dissipation structure of the side-light type backlight module according to the first preferred embodiment, taken along the line B-B in FIG. 2A; and

FIG. 3 is a schematic view of a light source heat-dissipation structure of a direct type backlight module according to a second preferred embodiment of the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

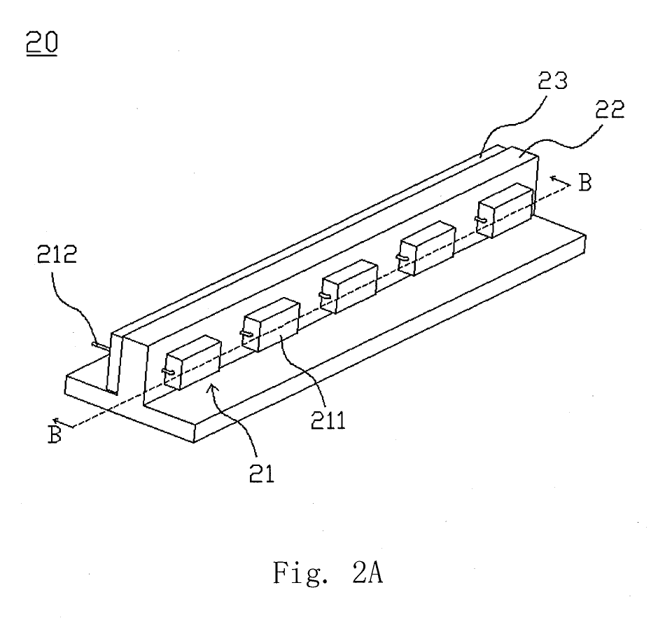

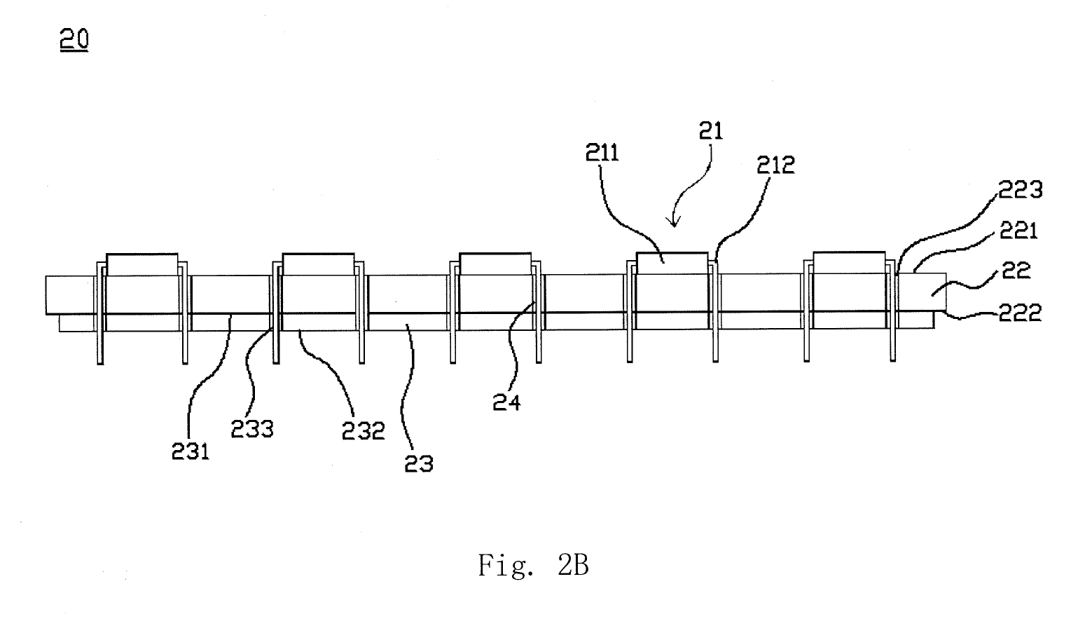

Referring to FIGS. 2A and 2B, schematic views of a light source heat-dissipation structure 20 of a side-light type backlight module according to a first preferred embodiment of the present invention are illustrated, wherein the light source heat-dissipation structure 20 is mainly applied to the field of liquid crystal display (LCD), and the light source heat-dissipation structure 20 comprises a light-source structure 21, a heat-dissipation base 22, a carrier 23 and at least one filler 24. The foregoing components of the present invention will be described more detailed hereinafter.

Referring to FIG. 2B, FIG. 2B is a cross-sectional view of the light source heat-dissipation structure 20 of the side-light type backlight module according to the first preferred embodiment, taken along the line B-B in FIG. 2A. The light source heat-dissipation structure 20 of the first preferred embodiment is a light bar of a light emitting diode of a side backlight module, so that the light source heat-dissipation structure 20 can be assembled to at least one side of an optical film of a backlight module for providing a side-light type backlight. Moreover, the at least one light-source structure 21 has at least one light-emitting diode 211 and at least one lead 212 respectively. The light-emitting diode 211 means that a whole light-emitting diode package structure comprises a molding compound, at least one light-emitting diode chip and a lead frame (or circuit board) from top to bottom in turn. A bottom of the at least one lead frame or a circuit board is disclosed, and the lead frame or a circuit board has the at least one lead 212 to import external power source for the light-emitting diode 211 can produce a specific light beam.

Referring still to FIG. 2B, the heat-dissipation base 22 of the first preferred embodiment has a supporting surface 221, an attachment surface 222 and at least one first through hole 223. The at least one first through hole 223 passes through the supporting surface 221 and the attachment surface 222, and the light-source structure 21 is fixed on the heat-dissipation base 22. The heat-dissipation base 22 is made of good thermal conductivity materials having better heat-dissipation efficiency, such as various metals or alloys and especially as a metal heat-dissipation base or an alloy heat-dissipation base that are made of aluminum (Al), aluminum alloys, or materials comprising aluminum, for helping the at least one light-emitting diode 211 or the carrier 23 conducting heat and dissipating heat in accordance with good properties of thermal conductivity and dissipation of the heat-dissipation base 22. If necessary, a contact part between the at least one light-emitting diode 111 and the supporting surface 121 of the heat-dissipation base 12 also can be coated with sufficient thermal conductive adhesive (non-shown) for a better efficiency of conducting heat and dissipating heat between the at least one light-emitting diode 111 and the heat-dissipation base 12.

Referring to FIG. 2B again, the carrier 23 of the first preferred embodiment has a first surface 231, a second surface 232 and at least one second through hole 233. The at least one second through hole 233 pass through the first surface 231 and the second surface 232, and the first surface 231 of the carrier 23 is attached to the attachment surface 222 of the heat-dissipation base 22. The at least one first through hole 223 of the heat-dissipation base 22 and the at least one second through hole 233 of the carrier 23 are set with correspondingly overlapping. Moreover, the at least one light-emitting diode 211 also connects the at least one lead 212 respectively and is correspondingly set to the at least one first through hole 223 on the supporting surface 221 of the heat-dissipation base 22 respectively, so that the at least one lead 212 can successfully passes through the at least one first through hole 223 of the heat-dissipation base 22 and the at least one second through hole 233 of the carrier 23. The at least one lead 212 may stretch out from the second surface 232 of the carrier 23, so as to let the at least one lead 212 electrically connects with the carrier 23. The carrier 23 may be a printed circuit board (PCB), but not limited thereto. For example, the carrier 23 also may be chosen from an anodized aluminum substrate and others which can be set circuit patterns on a surface thereof.

Moreover, referring to FIG. 2B, the at least one first through hole 223 of the heat-dissipation base 22 and the at least one second through hole 233 of the carrier 23 are further filled with the filler 24. The filler 24 is used to let the at least one lead 212 of the at least one light-emitting diode 211 be steady fixed in the at least one first through hole 223 and the at least one second through hole 233 and be electrically isolated from the heat-dissipation base 22, wherein the filler 24 is preferably an insulating adhesive or other insulant. Besides, the filler 24 also can help the heat-dissipation base 22 to be firmly combined with the carrier 23, and there will not use the thermal conductive adhesive between the heat-dissipation base 22 and the carrier 23. So, it is helpful for decreasing production costs and whole thickness of the light source heat-dissipation structure 20 to carry out the purpose of compacting products.

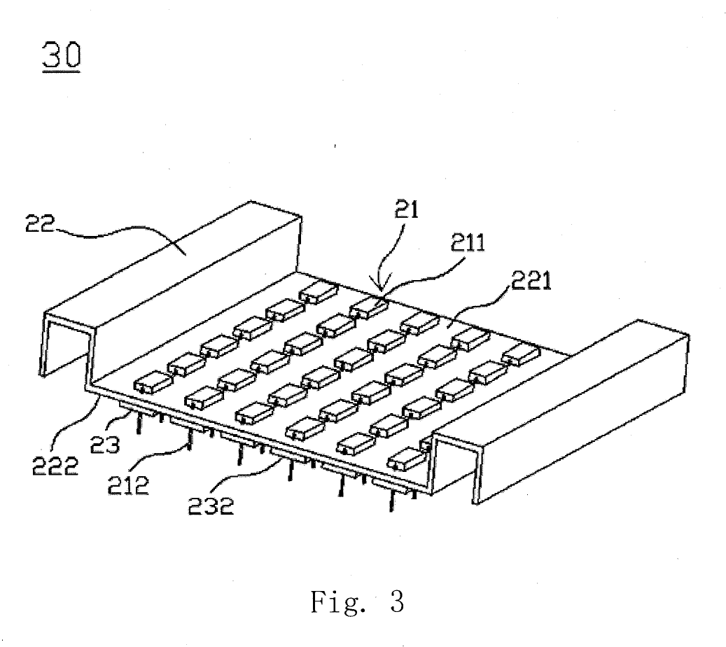

Referring now to FIG. 3, a schematic view of a light source heat-dissipation structure 30 of a direct type backlight module according to a second preferred embodiment of the present invention is illustrated. The second preferred embodiment of the present invention is similar to the light source heat-dissipation structure 20 of the first embodiment of the present invention, so as to use similar terms and numerals of the first embodiment. In the second preferred embodiment of the present invention, the light source heat-dissipation structure 30 comprises at least one light-source structure 21, a heat-dissipation base 22 which is common used, a plurality of carriers 23 which are separately set and at least one filler 24 (as shown in FIG. 2B). But, the differences of the second embodiment is characterized in that the light source heat-dissipation structure 30 is a direct type light-emitting diode light bar which comprises more light-source structures 21, and therefore the light source heat-dissipation structure 30 can be assembled on a right bottom of an optical film for providing a direct type backlight. It should be noted that the heat-dissipation base 22 of the second preferred embodiment of the present invention essentially is a structure of a backplane with a metal material.

Referring to FIGS. 2A, 2B, and 3, the advantages of the foregoing features of the first and second embodiments of the present invention are that: the light-source structure 21, the heat-dissipation base 22 and the carrier 23 are combined with each other in turn, wherein the heat-dissipation base 22 directly supports and thermally contacts the light-source structure 21. Therefore, it is helpful to the light-source structure 21 directly conducts heat and dissipates heat in accordance with the good properties of thermal conductivity and dissipation of the heat-dissipation base 22, and then the heat-dissipation efficiency and the lifetime of the light-source structure 21 can be relatively enhanced. Furthermore, the carrier 23 also will not be directly affected by the heat energy which comes from the light-source structure 21, so the lifetime of the carrier 23 can be relatively enhanced. In addition, the filler 24 which is filled in the first through hole 223 of the heat-dissipation base 22 and the second through hole 233 of the carrier 23 not only electrically isolates the lead 212 of the light-source structure 21 from the heat-dissipation base 22, but help the heat-dissipation base 22 to be firmly combined with the carrier 23, so that there may not use the thermal conductive adhesive between the heat-dissipation base 22 and the carrier 23. For these reasons, it is helpful for decreasing production costs and whole thickness of the light source heat-dissipation structure 20, 30 and to carry out the purpose of compacting products.

The present invention has been described with a preferred embodiment thereof and it is understood that many changes and modifications to the described embodiment can be carried out without departing from the scope and the spirit of the invention that is intended to be limited only by the appended claims.

1. A light source heat-dissipation structure of a backlight module, characterized in that: the light source heat-dissipation structure of the backlight module comprises:
at least one light-source structure, each of which comprises at least one light-emitting diode and at least one lead;
a heat-dissipation base having a supporting surface, an attachment surface and at least one first through hole, wherein the at least one first through hole passes through the supporting surface and the attachment surface; and
a carrier having a first surface, a second surface and at least one second through hole, wherein the at least one second through hole passes through the first surface and the second surface, and the first surface is attached to the attachment surface of the heat-dissipation base;
wherein the at least one light-emitting diode of the at least one light-source structure is mounted on the supporting surface of the heat-dissipation base, and the at least one lead passes through the at least one first through hole of the heat-dissipation base and the at least one second through hole of the carrier and electrically connects to the carrier.

2. The light source heat-dissipation structure of the backlight module according to claim 1, characterized in that: each of the at least one first through hole of the heat-dissipation base and the at least one second through hole of the carrier is further filled with a filler, so that the at least one lead is fixed in the at least one first through hole and the at least one second through hole and is electrically isolated from the heat-dissipation base, and the heat-dissipation base is combined with the carrier.

3. The light source heat-dissipation structure of the backlight module according to claim 1, characterized in that: the heat-dissipation efficiency of heat-dissipation base is better than the heat-dissipation efficiency of the carrier, wherein the heat-dissipation base is a metal heat-dissipation base or an alloy heat-dissipation base, and the carrier is a circuit board.

4. A light source heat-dissipation structure of a backlight module, characterized in that: the light source heat-dissipation structure of the backlight module comprises:
at least one light-source structure, each of which comprises at least one lead;
a heat-dissipation base having a supporting surface, an attachment surface and at least one first through hole, wherein the at least one first through hole passes through the supporting surface and the attachment surface; and
a carrier having a first surface and at least one second through hole, wherein the at least one second through hole passes through the first surface and the second surface, and the first surface is attached to the attachment surface of the heat-dissipation base;
wherein the at least one light-source structure is mounted on the supporting surface of the heat-dissipation base, and the at least one lead of the at least one light-source structure passes through the at least one first through hole of the heat-dissipation base and the at least one second through hole of the carrier and electrically connects to the carrier.

5. The light source heat-dissipation structure of the backlight module according to claim 4, characterized in that: each of the light-source structure further comprises at least one light-emitting diode.

6. The light source heat-dissipation structure of the backlight module according to claim 5, characterized in that: the light source heat-dissipation structure is a side-light type light-emitting diode light bar or a direct type light-emitting diode light bar.

7. The light source heat-dissipation structure of the backlight module according to claim 4, characterized in that: each of the at least one first through hole of the heat-dissipation base and the at least one second through hole of the carrier is further filled with a filler, so that the at least one lead is fixed in the at least one first through hole and the at least one second through hole, and the heat-dissipation base is combined with the carrier.

8. The light source heat-dissipation structure of the backlight module according to claim 7, characterized in that: the filler is an insulating adhesive to electrically isolate the at least one lead from the heat-dissipation base.

9. The light source heat-dissipation structure of the backlight module according to claim 4, characterized in that: the carrier is a printed circuit board.

10. The light source heat-dissipation structure of the backlight module according to claim 4, characterized in that: the heat-dissipation base is a metal heat-dissipation base or an alloy heat-dissipation base.
